(19) United States
(12) Patent Application Publication
(10) Pub. No.: US 2008/0108498 A1
(43) Pub. Date: May 8, 2008

(54) METHOD FOR PREPARING A LARGE CONTINUOUS ORIENTED NANOSTRUCTURED MIXED METAL OXIDE FILM

(75) Inventors: Xue Duan, Beijing (CN); Lianying Wang, Beijing (CN); Miao Liu, Beijing (CN); Cang Li, Beijing (CN)

Correspondence Address: BLAKELY SOKOLOFF TAYLOR & ZAFMAN, 1279 OAKMEAD PARKWAY, SUNNYVALE, CA, 94085-4040, US

(73) Assignee: Beijing University of Chemical Technology, Beijing (CN)

(21) Appl. No.: 11/853,773

(22) Filed: Sep. 11, 2007

(30) Foreign Application Priority Data
Nov. 7, 2006 (CN) 200610114340.2

(51) Int. Cl. B01J 20/28

(52) U.S. Cl. 502/4; 502/102

(57) ABSTRACT

This invention provides a general method for preparing a large oriented nanostructured mixed metal oxide (MMO) film comprising the steps of (a) preparing a highly (00l)-oriented LDH film, and (b) calcining the LDH film at a temperature of 300° C. to 1300° C. for 10 min to 36 h to obtain an oriented nanostructured MMO film. In the oriented MMO film, MMO nanoparticles are densely packed and form defect-free films which have high thermal stability. The major advantage of the present method is that it can be used for mass-production of large continuous oriented nanostructured MMO films without using any templates, lattice-matched single-crystalline substrates and/or expensive equipment, and the composition of the prepared MMO films can be readily adjusted by changing the composition of the LDHs fims as the precursor.

### CROSS-REFERENCE TO RELATED APPLICATIONS

The present patent application claims priority from Chinese Patent Application No. 200610114340.2, filed on Nov. 7, 2006.

### TECHNICAL FIELD

The present invention relates to a method for preparing a large continuous oriented nanostructured mixed metal oxide film with uniform small densely packed nanoparticles and high thermal stability.

### BACKGROUND OF THE INVENTION

Nanoscale mixed metal oxide (hereinafter referred to as MMO) materials have chemical and physical properties different from those of the bulk single components, and have attracted much attention because of their potential applications in various fields such as catalysis, separation, magnetics, electrochemistry, luminescence, semiconductors and sensors. Construction of large continuous supported films or self-supporting films of nanoscale MMO with crystallographic orientation is highly desirable for some of the practical applications mentioned above.

Various growth techniques have been employed to synthesize MMO films. Vacuum-based methods such as chemical vapor deposition, sputtering, pulsed laser deposition and molecular beam epitaxy, need an expensive investment and are limited to line-of-sight production. Wet chemical methods involving use of a homogeneous solution can overcome some defects of vacuum-based methods. Among these methods, the sol-gel route has been widely investigated, but it has some inherent drawbacks in that the precursors, typically organometallic compounds, are expensive and sensitive to moisture in the air and need to be synthesized by a complicated process involving toxic organic solvents. More importantly, the available range of organic heterometallic precursors is severely limited. Moreover, it is very difficult to prepare high quality multi-metallic oxide films because of difficulties in controlling the stoichiometry and homogeneity of composition, orientation, and/or nanostructure. Therefore, devising a simple protocol for the fabrication of low-cost, large-scale, controlled growth nanostructured MMO films remains a considerable challenge.

### SUMMARY OF THE INVENTION

An object of the present invention is to provide a simple and mass-production method for preparing a large continuous oriented nanostructured MMO film with high thermal stability, without using any templates, structure-directing agents and/or lattice-matched single-crystalline substrates. The method provided in the present invention uses a single inorganic LDHs film as a precursor for the preparation of MMO films, wherein the nanostructure of the films can be controlled by changing the calcination temperature. In addition, the method provided in the present invention can be readily extended to a wide range of MMO oxide systems for specific applications by changing the metal composition of the LDH film as the precursor.

The method provided in the present invention includes the following steps:

(a) preparing a highly (00l)-oriented LDHs film, and

(b) calcining the LDH film at a temperature of 300° C. to 1300° C. for 10 min to 36 h to obtain oriented nanostructured MMO film.

Layered double hydroxides (LDHs) are a family of two dimensional anionic clays that can be represented by the general formula [M²⁻₁₋ₓM³⁺ₓ(OH)₂]Aⁿ⁻_{x/n}.mH₂O, wherin M²⁺ represents at least one divalent cation selected from the group consisting of Mg²⁺, Ni²⁺, Zn²⁺, Co²⁺, Mn²⁺, Cd²⁺, and Ca²⁺; M³⁻ represents at least one trivalent cation selected from the group consisting of Al³⁻, Fe³⁻, Cr³⁻ and Ga³⁺; the value of x is equal to the molar ratio of M²⁺/(M²⁺+M³⁺), and is in a range from ⅔ to ⅘; Aⁿ⁻ represents an anion, such as CO₃²⁻, NO₃⁻, etc.; n represents the charge number of the anion; and m is in a range from 0.5 to 2.5. LDHs containing three or more cations can also be prepared. Therefore, a large class of isostructural materials can be obtained by changing the nature of the metal cation, the molar ratio of M²⁺/M³⁺, and the type of the interlayer anion. Unlike organic heterometallic precursors, the inorganic LDHs nanoparticles are readily available, low in cost, and stable both in solid form and in aqueous suspension. Therefore, LDHs nanoparticles can serve as versatile precursors for nanostructured MMO materials. But up to now, the LDHs-derived oxide materials have always been obtained in opaque powder form and this has severely constrained the development of their potential applications. Nevertheless, the recent successful synthesis of uniform small LDH nanoparticles as well as their orderly oriented assembly appears to render it possible to prepare mixed metal oxide films with LDHs as precursor.

In step (a), the LDHs film may be prepared by direct solvent evaporation of an aqueous suspension of the LDHs nanoparticles (see CN 180028A). The amount of the LDHs nanoparticles contained in the suspension can be 0.1-20 wt %. The solvent evaporation can be carried out at a temperature of 20° C. to 80° C. The thickness of the LDHs film can be controlled from tens to hundreds of microns by changing the concentration of the suspension and the evaporation conditions. LDHs nanoparticles may be prepared by a known method in the art such as coprecipitation method, hydrothermal method, or ion-exchange method.

In step (b), the LDH film may be calcined at a temperature not less than 300° C. but below 700° C. for 10 min to 36 h to obtain an oriented nanostructured MMO film consisting of M^{3|}-doped M^{2|}O. Alternatively, in step (b), the LDH film may be calcined at a temperature of 700° C. to 1300° C. for 10 min to 36 h to obtain an oriented nanostructured MMO film consisting of M²⁺O mixed with an M²⁺M³⁺₂O₄ spinel composite phase.

In the oriented nanostructured MMO film obtained in step (b), M²⁺ is at least one divalent cation selected from the group consisting of Mg²⁺, Ni²⁺, Zn²⁻, Co²⁺, Mn²⁺, Cd²⁻, and Ca²⁻; M³⁺ is at least one trivalent cation selected from the group consisting of Al³⁺, Fe³⁺, Cr³⁺ and Ga³⁺; and the molar ratio of M(II) to M(III) is in a range from 2:1 to 4:1.

The oriented nanostructured MMO film has preferred (111) orientation when the divalent cation is Mg²⁺, Ni²⁻, Co²⁺, Mn²⁺, Cd²⁺, Ca²⁺ or the combination thereof. On the other hand, the oriented nanostructured MMO film has preferred (002) orientation when the divalent cation is Zn²⁺.

The oriented nanostructured MMO film consists of uniform small densely packed MMO nanoparticles.

According to the method in the present invention, it is possible to prepare an oriented nanostructured MMO films with large dimensions up to several centimetres.

The composition and microstructure of the prepared MMO film were characterized in detail by XRD and SEM techniques. The prepared MMO films have highly preferred orientation which arises from the oriented interactions in, and topotactic conversion of, the precursor films. The narrow distribution of MMO nanoparticle size enables the formation of dense continuous films which are strikingly smooth, and there are no holes or aggregation on the surface of the film, even after high temperature treatment.

### BRIEF DESCRIPTION OF THE DRAWINGS

FIG. 1A illustrates the X-ray diffraction (XRD) patterns of NiAl-LDH film (a) and NiAl-MMO films prepared at 500° C. (b) and 900° C. (c).

FIG. 1B illustrates the XRD patterns of the NiAl-MMO films after being ground into powder.

FIG. 2 is the scanning electron microscope (SEM) images of the NiAl-LDH film (A) and NiAl-MMO film prepared at 900° C.: (B) top view, (C) partial enlarged view of (B), (D) edge view with a high-resolution image of this structure shown in the inset image.

### DETAILED DESCRIPTION OF THE PREFERRED EMBODIMENTS

Hereinafter, the present invention will be described through the following examples. However, the present invention is not limited to the following examples.

### EXAMPLE 1

An aqueous solution containing 1.2 M Ni(NO₃)₂.6H₂O and 0.6 M Al(NO₃)₃.9H₂O and an aqueous solution of NaOH (3.6 M) were simultaneously added to a colloid mill with a rotating speed of 3000 rpm, and mixed for 1 min. The resulting mixture was removed from the colloid mill and aged at 100° C. for 48 h. The final product was washed several times with water by centrifugation, to obtain NiAl-NO₃ LDHs nanoparticles.

The above LDHs nanoparticles were added into deionized water to obtain an aqueous suspension containing 2 wt. % of LDHs nanoparticles, and the pH of the aqueous suspension was adjusted to about 7. Then the aqueous suspension was poured in a glass vessel and evaporated in air at 40° C. for 10 h, to obtain oriented LDHs films.

The above oriented LDHs films were peeled off from the glass vessel. And then, some LDHs films were calcined at 500° C. for 6 h; and the other LDHs films were calcined at 900° C. for 6 h, to obtain oriented MMO films, respectively. The MMO powders were prepared by thorough grinding of the corresponding MMO films.

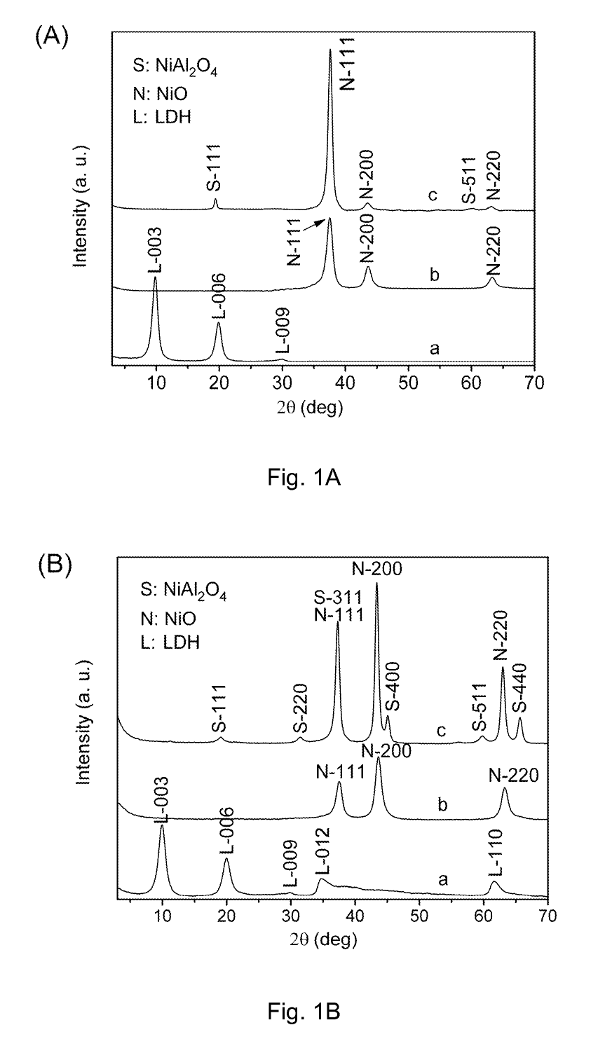

FIG. 1A illustrates the XRD patterns of the above NiAl-LDH film (a), and NiAl-MMO films prepared at 500° C. (b) and 900° C. (c). Observation of the series of (00l) reflections together with the absence of any non-basal reflections (h, k≠0) in the XRD pattern of the NiAl-LDH film (a) reveals the extremely well (00l)-oriented assemblies of hexagonal LDH nanoparticles. NiAl-MMO films prepared at 500° C. (b) have three broad XRD peaks attributed to the reflections of cubic Al-doped NiO, and their lattice parameter (0.415 nm) is slightly less than that of pure NiO [0.41769 nm, JCPDS No. 47-1049]. In NiAl-MMO films prepared at 900° C. (b), phase separation takes place to give a cubic inverse spinel NiAl₂O₄ phase [JCPDS No. 10-0339] in addition to NiO. The XRD patterns of the NiAl-MMO films after being ground into powder form (FIG. 1B) are consistent with the literature. The average crystallite sizes, estimated using the Scherrer equation, are 5.5 nm for Al-doped NiO prepared at 500° C., and 13.5 nm and 13.6 nm respectively for NiO and NiAl₂O₄ prepared at 900° C.

The intensities of the XRD peaks observed for the films themselves and the powders obtained by grinding the films show significant differences. As shown in FIG. 1A, the most intense reflection of cubic NiO is (111) in the ordered film, while the dominant peak is (200) for the randomly oriented NiO powder. Similarly, the most intense peak for the NiAl₂O₄ phase in the film corresponds to the (111) reflection, however, the reflections of (400) and (440) are more intense for the powdered form. These results indicate that the NiAl-MMO films obtained by calcining (00l)-oriented NiAl-LDH films have a (111) preferred orientation and both NiO and NiAl₂O₄ phases align with their (111) facets parallel to the film face. The preferred (111) orientation of the NiAl-MMO films can be rationalized in terms of a topotactic mechanism, that is, a topotactic transformation: (00l) NiAl-LDH→(111) Al-doped NiO or (00l) NiAl-LDH→(111) NiO+(111) NiAl₂O₄.

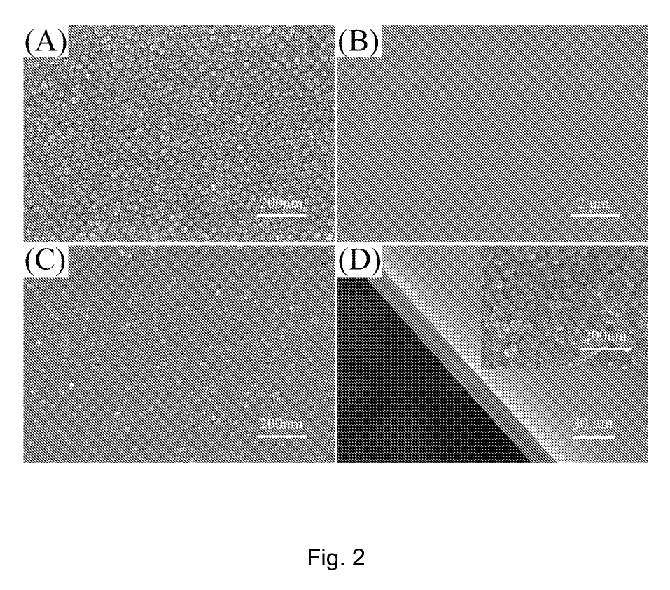

The morphology of the NiAl-LDHs films and NiAl-MMO films was studied by scanning electron microscopy (SEM). As shown in FIG. 2 (A), in the NiAl-LDHs fim, the NiAl-LDHs nanoparticles orient themselves in a uniform dense array. SEM image at high magnification of the NiAl-MMO film prepared at 500° C. reveals a similar dense arrangement of uniform spherical nanoparticles. As shown in FIG. 2B, even the NiAl-MMO films prepared at 900° C. retain a surprisingly flat surface without any hole or cracking. A high magnification SEM image of the MMO film shows the presence of densely packed nanoparticles with uniform size and shape (FIG. 2C). The average size of these particles is about 15 nm, which is similar to that estimated from XRD, vide supra. The edge view image shows that the MMO film is homogeneous in thickness with similar structure to the surface except for weakly aggregation (FIG. 2D).

### EXAMPLE 2

The NiFe-MMO films were prepared by the same method as described in Example 1, except that Fe(NO₃)₃ was used instead of Al(NO₃)₃.

### EXAMPLE 3

The ZnAl-MMO films were prepared by the same method as described in Example 1, except that Zn(NO₃)₂ was used instead of Ni(NO₃)₂. The Al doped ZnO film has preferred (002) orientation when the calcination temperature is in a range from 300° C. to about 700° C.

1. A method for preparing a large continuous oriented nanostructured MMO film, comprising:
(a) preparing a highly (00l)-oriented LDHs film, and
(b) calcining the LDHs film at a temperature of 300° C. to 1300° C. for 10 min to 36 h to obtain an oriented nanostructured MMO film.

2. The method of claim 1, wherein in step (b), the LDHs film is calcined at a temperature of 300° C. to 700° C. for 10 min to 36 h to obtain an oriented nanostructured MMO film consisting of M³⁺-doped M²⁺O.

3. The method of claim 1, wherein in step (b), the LDHs film is calcined at a temperature higher than 700° C. but no less than 1300° C. for 10 min to 36 h to obtain an oriented nanostructured MMO film consisting of M²⁺O mixed with an M²⁺M³⁺₂O₄ spinel composite phase.

4. The method of claim 2, wherein M²⁺ represents at least one divalent cation selected from the group consisting of Mg²⁺, Ni²⁺, Zn²⁺, Co²⁺, Mn²⁺, Cd²⁺, and Ca²⁺; M³⁺ represents at least one trivalent cation selected from the group consisting of Al³⁺, Fe³⁺, Cr³⁺ and Ga³⁺; and the molar ratio of M²⁺ to M³⁺ in the oriented nanostructured MMO film is in a range from 2:1 to 4:1.

5. The method of claim 2, wherein the oriented nanostructured MMO film has preferred (111) orientation when the divalent cation is Mg²⁺, Ni²⁺, Co²⁺, Mn²⁺, Cd²⁺, Ca²⁺ or the combination thereof.

6. The method of claim 2, wherein the oriented nanostructured MMO film has preferred (002) orientation when M²⁺ is Zn²⁺.

7. The method of claim 1, wherein the highly (00l)-oriented LDHs film is prepared by direct solvent evaporation of an aqueous suspension of the LDHs nanoparticles.

8. The method of claim 7, wherein the amount of the LDHs nanoparticles contained in the suspension is 0.1-20 wt %, and the solvent evaporation is carried out at a temperature of 20° C. to 80° C.

9. The method of claim 1, wherein the oriented nanostructured MMO film consists of uniform small densely packed MMO nanoparticles.

10. The method of claim 3, wherein M²⁺ represents at least one divalent cation selected from the group consisting of Mg²⁺, Ni²⁺, Zn²⁺, Co²⁺, Mn²⁺, Cd²⁺, and Ca²⁺; M³⁺ represents at least one trivalent cation selected from the group consisting of Al³⁺, Fe³⁺, Cr³⁺ and Ga³⁺; and the molar ratio of M²⁺ to M³⁺ in the oriented nanostructured MMO film is in a range from 2:1 to 4:1.

11. The method of claim 3, wherein the oriented nanostructured MMO film has preferred (111) orientation when the divalent cation is Mg²⁺, Ni²⁺, Co²⁺, Mn²⁺, Cd²⁺, Ca²⁺ or the combination thereof.
